(19) United States
(12) Patent Application Publication
(10) Pub. No.: US 2026/0328708 A1
(43) Pub. Date: Oct. 22, 2026

(54) X-RAY INSPECTION APPARATUS AND X-RAY INSPECTION SYSTEM

(71) Applicant: ANRITSU CORPORATION, Kanagawa (JP)

(72) Inventors: Takeshi TSUNODA, Kanagawa (JP); Kazunori NAKAYAMA, Kanagawa (JP); Koji YOSHIDA, Kanagawa (JP); Naoya SAITO, Kanagawa (JP)

(21) Appl. No.: 19/529,216

(22) Filed: Feb. 4, 2026

(30) Foreign Application Priority Data
Feb. 13, 2025 (JP) 2025-021787

(51) Int. Cl. G01N 23/04; G01N 23/083; G06T 7/00; G06V 10/764; G06V 10/77; G06V 20/52; G06V 40/10; G21F 3/00

(52) U.S. Cl. CPC G01N 23/04; G01N 23/083; G06T 7/001; G06V 10/764; G06V 10/77; G06V 20/52; G21F 3/00; G01N 2223/401; G01N 2223/643; G06T 2207/10016; G06T 2207/10116; G06T 2207/20036; G06T 2207/20081; G06T 2207/30196; G06V 40/10

(57) ABSTRACT

An X-ray inspection apparatus includes: an X-ray imaging section that images an inspection object with X-rays in a housing; an image processing unit that inspects the inspection object based on an X-ray image from the X-ray imaging section; a shielding curtain of the opening portion; an opening imaging unit that images a predetermined imaging region and outputs the predetermined imaging region as an opening portion image during a shielding period of the opening portion; an image feature recognition unit that recognizes a morphological feature relating to a shielding state of the opening portion from the opening portion image as a predetermined image feature value; and a safety determination unit that determines safety relating to a shielding function of the shielding curtain at the opening portion based on the predetermined image feature value.

### TECHNICAL FIELD

The present invention relates to an X-ray inspection apparatus and an X-ray inspection system, and particularly to an X-ray inspection apparatus and an X-ray inspection system that inspect a quality state of an inspection object based on an X-ray inspection image of the inspection object obtained by imaging the inspection object with X-rays.

### BACKGROUND ART

In the related art, an X-ray inspection apparatus and an X-ray inspection system that detect a quality state of an inspection object, for example, a defective state such as foreign matter contamination, out-of-stock, or defective sealing of a package, based on an X-ray inspection image obtained by imaging with X-rays the inspection object being conveyed, or that perform volume measurement or relative mass measurement are known.

In such an X-ray inspection apparatus or an X-ray inspection system, in general, a housing of the X-ray inspection apparatus has an X-ray shielding structure therein in order to perform X-ray imaging of the inspection object, and at each of an inlet and an outlet for an article, a shielding curtain containing an X-ray shielding metal (lead, stainless steel, or the like) is provided in a curtain shape with a predetermined number of splits having a plurality of strip-shaped portions. In addition, since the inlet and the outlet for the article have a structure that allows a person's hand to enter the inlet and the outlet, various measures have been taken to prevent X-ray exposure that may affect an operator.

As the related art of such an X-ray inspection apparatus or an X-ray inspection system of this type, for example, there is one that is provided with a light-emitting and light-receiving element that detects passage of an inspection object within a predetermined monitoring region set inside the inlet and the outlet for an article, determines whether an object or a human body has passed through the monitoring region based on whether a change in detection signal level of the light-emitting and light-receiving element corresponds to a preset article passage time (light shielding time), and limits an X-ray output to less than a predetermined amount in a case where passage of a human body is determined to prevent X-ray exposure in advance, while generating an alarm output (see, for example, Patent Document 1).

In addition, as the related art of such an X-ray inspection apparatus or an X-ray inspection system, there is one that includes a shielding curtain unit configured with a base detachably mountable above a conveyor with respect to a housing having an inlet and an outlet for an article and a front opening and closing door and a plurality of shielding curtains on an inlet side and an outlet side mounted on the base, in which, when the unit is mounted on the housing, a shutter operating tool provided in the unit moves shutter plate on a housing side to expose an operation switch hidden inside the housing, and when the opening and closing door is closed, an operation piece on an upper end side of the opening and closing door operates the operation switch, thereby enabling the X-ray inspection apparatus to operate (see, for example, Patent Document 2).

Furthermore, as the related art of such an X-ray inspection apparatus or an X-ray inspection system, there is one that is provided with an infrared sensor for object detection that detects a temperature change in monitoring region above an inlet and an outlet, in which whether or not a human body has entered the monitoring region can be determined based on a difference in change pattern of a detection temperature by the infrared sensor between a case where X-ray inspection is performed while only an inspection object is conveyed at a specified conveyance speed and a case where a human body is detected instead of the inspection object, and when the human body is detected by the infrared sensor, an X-ray output of an X-ray generator is reduced (see, for example, Patent Document 3).

### RELATED ART DOCUMENT

### Patent Document

[Patent Document 1] JP-A-2001-311699
[Patent Document 2] JP-A-2003-279500
[Patent Document 3] JP-A-2018-165634

### DISCLOSURE OF THE INVENTION

### Problem that the Invention is to Solve

However, although the X-ray inspection apparatuses and X-ray inspection systems in the related art described above can detect a case where a person's hand or the like approaches or is inserted into the inlet and outlet for an article immediately before the X-ray inspection, the X-ray inspection apparatuses and X-ray inspection systems cannot reliably detect a decrease in safety due to deterioration of the shielding curtain such as a lead rubber curtain and are thus insufficient for sufficiently improving safety of the X-ray inspection apparatus.

Specifically, even in a case where the shielding curtain is disposed in a suitable form for suppressing leakage of X-rays according to a shape or a property of the inspection object, since the shape or a conveyance form of the inspection object is often diversified, for example, various forms of deterioration of the shielding curtain, such as diverse warping that produces gaps that are difficult to measure, or irregular fraying or wear marks of the conveyance belt that can cause a change in color tone may occur, which can cause concern about a decrease in safety.

In addition, for example, although it is possible to detect breakage or detachment of the strip-shaped portion of the shielding curtain such as the lead rubber curtain, there is a problem in that a gap between the adjacent strip-shaped portions in multiple directions or at multiple points or various gaps between the shielding curtain and the conveyance belt cannot be reliably detected, and there is also a problem in that an apparatus configuration becomes complicated and costly in order to detect various abnormalities of shielding performance.

Therefore, an object of the present invention is to provide an X-ray inspection apparatus and an X-ray inspection system that can reliably detect various deteriorations or abnormalities of shielding performance at an opening portion having a shielding curtain with a simple configuration and can sufficiently improve safety.

### Means for Solving the Problem

As an example of an embodiment, there is provided an X-ray inspection apparatus including: a housing having an opening portion through which an inspection object is conveyed in a predetermined direction by a conveyor; an X-ray imaging section that images the inspection object with X-rays in the housing; an image processing unit that inspects quality of the inspection object based on an X-ray image from the X-ray imaging section; a shielding curtain that is disposed at the opening portion; an opening imaging unit that images a predetermined imaging region including the opening portion and outputs the predetermined imaging region as an opening portion image at a timing at which the inspection object does not pass through the opening portion; an image feature recognition unit that recognizes a morphological feature of a shielding state of the opening portion that is classifiable from the opening portion image from the opening imaging unit as a predetermined image feature value; and a safety determination unit that determines safety relating to a shielding function of the shielding curtain at the opening portion based on the predetermined image feature value recognized by the image feature recognition unit.

With this configuration, when the predetermined imaging region including the opening portion is imaged by the opening imaging unit and is output as the opening portion image at the timing at which the inspection object does not pass through the opening portion, and the classifiable morphological feature of the shielding states of the opening portion from the opening portion image is recognized as the predetermined image feature value by the image feature recognition unit, safety relating to the shielding function of the shielding curtain in the opening portion is accurately determined by the safety determination unit based on the image feature value. As a result, the X-ray inspection apparatus can reliably detect various deteriorations or abnormalities of shielding performance at the opening portion having the shielding curtain with a simple configuration and can sufficiently improve safety. Here, the timing at which the inspection object does not pass through the opening portion is a shielding period in which the shielding curtain is in a stable shielding state in a non-inspection period in which the inspection of the inspection object is stopped or in a case where a conveyance interval of the inspection object is large to a degree at which the stable shielding state of the shielding curtain can occur even in an inspection period.

As an example of the embodiment, the predetermined imaging region may include surfaces of the shielding curtain exposed in the opening portion and a partial conveyance surface of the conveyor located directly below the opening portion, at least a first gap between the surfaces of the shielding curtain and a second gap between the shielding curtain and the partial conveyance surface of the conveyor may each be recognized as the predetermined image feature value by the image feature recognition unit from the opening portion image, a feature value storage unit that stores each of the recognized first gap and second gap as a reference image feature value may be provided, and the safety determination unit may determine the safety relating to the shielding function of the shielding curtain at the opening portion by comparing the predetermined image feature value of the opening portion image recognized by the image feature recognition unit during a recent predetermined period with the reference image feature value corresponding to at least the first gap and the second gap.

In this case, for example, in a case where a gap between strip-shaped portions increases or a gap on a lower end side of the shielding curtain increases due to deterioration of a plurality of the strip-shaped portions in the shielding curtain having a curtain shape having a predetermined number of splits, in the opening portion image acquired under the state, at least the first gap that is a gap between the surfaces of the shielding curtain or the second gap that is a gap between the shielding curtain and the partial conveyance surface of the conveyor appears. In this case, the first gap and the second gap are recognized as the image feature value by the image feature recognition unit and are stored in the feature value storage unit as the reference image feature value. Then, the safety determination unit accurately determines the safety relating to the shielding function of the opening portion based on a result of comparing the image feature value of the opening portion image recognized by the image feature recognition unit during the current period or a recent predetermined period including the current period with at least the reference image feature value of the first and second gaps.

As an example of the embodiment, the opening imaging unit may image the opening portion including a shielding state of the shielding curtain at a predetermined imaging cycle during a shielding period in which the inspection object does not pass through the opening portion, and repeatedly output an opening portion image including the shielding state of the shielding curtain, the feature value storage unit may be configured to store and accumulate the predetermined image feature value of the opening portion image for the opening portion image including the shielding state of the shielding curtain at a predetermined cycle, and the safety determination unit may predict and determine occurrence of an abnormality in the shielding state of the shielding curtain based on the predetermined image feature value of the opening portion image stored in the feature value storage unit at the predetermined cycle.

In this case, during the shielding period of the opening portion, the opening portion image including the shielding state of the shielding curtain is repeatedly output at a predetermined imaging cycle, and the predetermined image feature value of the output opening portion image is sequentially stored and accumulated in the feature value storage unit. Then, the safety determination unit predicts and determines the occurrence of an abnormality in the shielding state of the shielding curtain based on the predetermined image feature value of a plurality of the opening portion images sequentially stored in the feature value storage unit and the degree of deterioration of the shielding curtain or the conveyance belt, which is recognized as the degree of change.

As an example of the embodiment, the feature value storage unit may store the predetermined image feature value appearing in the opening portion image when a shielding function of the opening portion is normal as a reference image feature value in a normal state, and store the predetermined image feature value appearing in the opening portion image when the shielding function of the opening portion is abnormal as a reference image feature value in an abnormal state, and the safety determination unit may determine the safety relating to the shielding function of the shielding curtain at the opening portion by comparing the predetermined image feature value of the opening portion image recognized by the image feature recognition unit during the recent predetermined period with the reference image feature value including at least the reference image feature value in the normal state and the reference image feature value in the abnormal state.

In this case, the safety determination unit determines the safety relating to the shielding function of the shielding curtain at the opening portion by comparing the image feature value of the opening portion image recognized by the image feature recognition unit during the recent predetermined period with the reference image feature value including at least the reference image feature value in the normal state and the reference image feature value in the abnormal state, which are stored in the feature value storage unit. Then, in a case where a significant change in image feature values occurs toward the reference image feature value in the abnormal state in the opening portion image recognized during the recent predetermined period, a decrease in the safety relating to the shielding function of the shielding curtain at the opening portion is determined.

As an example of the embodiment, the X-ray inspection apparatus may further include a trained model that has been trained to detect, using a camera video in which a deterioration and wear state of at least one of a deterioration and wear state of the shielding curtain and a deterioration and wear state of a conveyance belt constituting the conveyor is imaged, an object in the deterioration and wear state, in which the safety determination unit may determine safety of the X-ray inspection apparatus based on the trained model and the opening portion image captured by the opening imaging unit.

In this case, since the trained model that has been trained to detect an object in the deterioration and wear state using the camera video in which the deterioration and wear state of the shielding curtain and/or the conveyance belt of the conveyor is imaged is provided, even in a case where the deterioration and wear state is not easily measurable quantitatively as a specific location or for a specific deterioration type, a significant deterioration state can be accurately determined by the object detection method at a determination level of an expert. Therefore, the safety determination unit can accurately determine the safety based on the trained model and the opening portion image captured by the opening imaging unit.

As an example of the embodiment, the X-ray inspection apparatus may further include a trained model that has been trained in advance to recognize an object using a camera video in which the inspection object is imaged, in which the safety determination unit may determine safety of the X-ray inspection apparatus based on the trained model and the opening portion image captured by the opening imaging unit.

In this case, in a case where an object other than the inspection object is recognized as an object from the opening portion image based on the camera video by the trained model, it is recognized that an object other than the inspection object approaches the opening portion, and a state in which the safety of the apparatus is impaired can be determined in advance. On the other hand, in a case where the inspection object is recognized as an object from the opening portion image based on the camera video by the trained model, it is determined that the inspection object approaches the opening portion and a state in which the safety of the apparatus is maintained can be determined.

As an example of the embodiment, the image feature recognition unit may have a human body detection function of recognizing that a part of a human body is inserted into the predetermined imaging region including the opening portion based on the opening portion image, the safety determination unit may determine safety of the X-ray inspection apparatus based on detection information by the human body detection function when it is detected by the human body detection function of the image feature recognition unit that the part of the human body is inserted into the predetermined imaging region, and the X-ray inspection apparatus may further include an inspection control section that stops X-ray irradiation by the X-ray imaging section and conveyance driving of the conveyor and outputs error information relating to X-ray inspection when it is detected by the human body detection function that the part of the human body is inserted into the predetermined imaging region.

In this case, not only the safety determination according to the degree of deterioration and wear of the shielding curtain and the conveyance belt but also the safety determination based on the human body detection function can be accurately executed. Then, in a case where the part of the human body is inserted into the predetermined imaging region, the insertion is quickly and accurately detected by the human body detection function, the X-ray irradiation by the X-ray imaging section and the conveyance driving of the conveyor are stopped, and error information relating to t the X-ray inspection can be quickly and accurately output.

As an example of the embodiment, the X-ray inspection apparatus may further include a still image storage unit that stores a still image obtained from a camera video, in which the image feature recognition unit may perform image processing for recognizing, as the predetermined image feature value, a classifiable morphological feature relating to the shielding state of the opening portion appearing in the opening portion image and to the detection information by the human body detection function, based on the still image stored in the still image storage unit, and the safety determination unit may determine safety relating to the shielding state of the opening portion appearing in the opening portion image and to the detection information by the human body detection function.

In this case, a change in the shielding state of the opening portion or the insertion operation of the part of the human body can be quickly and accurately detected as a change in the image feature value based on a plurality of the still images obtained at a relatively short time interval from the camera video, and the safety determination can be more accurately performed.

As an example of the embodiment, there is provided an X-ray inspection system including: an X-ray inspection apparatus including a housing having an opening portion through which an inspection object is conveyed in a predetermined direction by a conveyor, an X-ray imaging section that images the inspection object with X-rays in the housing, an image processing unit that inspects quality of the inspection object based on an X-ray image from the X-ray imaging section, and a shielding curtain that is disposed at the opening portion; an opening imaging camera that is provided outside the X-ray inspection apparatus in an independent manner to image a predetermined imaging region including the opening portion and output the predetermined imaging region as an opening portion image at a timing at which the inspection object does not pass through the opening portion; an image feature recognition unit that recognizes a morphological feature of a shielding state of the opening portion that is classifiable from the opening portion image from the opening imaging camera as a predetermined image feature value; and a safety determination unit that determines safety relating to a shielding function of the shielding curtain at the opening portion based on the predetermined image feature value recognized by the image feature recognition unit.

With this configuration, when the predetermined imaging region including the opening portion is imaged by the opening imaging camera and is output as the opening portion image at the timing at which the inspection object does not pass through the opening portion, and the classifiable morphological feature of the shielding states of the opening portion from the opening portion image is recognized as the predetermined image feature value by the image feature recognition unit, safety relating to the shielding function of the shielding curtain in the opening portion is accurately determined by the safety determination unit based on the image feature value. As a result, the X-ray inspection system can reliably detect various deteriorations or abnormalities of shielding performance at the opening portion of the X-ray inspection apparatus having the shielding curtain with a simple configuration and can sufficiently improve safety.

### Advantage of the Invention

According to the present invention, it is possible to provide an X-ray inspection apparatus and an X-ray inspection system that can reliably detect various deteriorations or abnormalities of shielding performance at an opening portion having a shielding curtain with a simple configuration and can sufficiently improve safety.

### BRIEF DESCRIPTION OF THE DRAWINGS

FIG. 1 is a schematic configuration diagram of an X-ray inspection apparatus according to an embodiment of the present invention.

FIG. 2A is a partial perspective view showing an opening portion on an inlet side for an inspection object in the X-ray inspection apparatus according to the embodiment of the present invention, and FIG. 2B is a partial perspective view showing an opening portion on an outlet side for the inspection object in the apparatus.

FIG. 3 is a partial plan view illustrating a configuration in the vicinity of the opening portion on the inlet side in the X-ray inspection apparatus according to the embodiment of the present invention, including a part of an upstream conveyance path.

FIG. 4 is a perspective view of main parts showing a shielding curtain unit that is attachably and detachably provided on a housing in the X-ray inspection apparatus according to the embodiment of the present invention.

FIG. 5 is a curtain disposition explanatory view including a partial cross section of a shielding curtain and a conveyance surface of a conveyor as viewed in a conveyance direction in the X-ray inspection apparatus according to the embodiment of the present invention.

FIGS. 6A to 6C are deterioration form explanatory views illustrating a plurality of different functional deterioration states of the shielding curtain in the X-ray inspection apparatus according to the embodiment of the present invention in an overall form.

FIGS. 7A to 7F are deterioration form partial explanatory view illustrating each of plurality of functional deterioration sites of the shielding curtain in the X-ray inspection apparatus according to the embodiment of the present invention in a predetermined image size.

FIG. 8 is a schematic configuration diagram of an X-ray inspection system including the X-ray inspection apparatus according to another embodiment of the present invention.

### BEST MODE FOR CARRYING OUT THE INVENTION

Hereinafter, an embodiment according to the present invention will be described with reference to the drawings.

### Embodiment

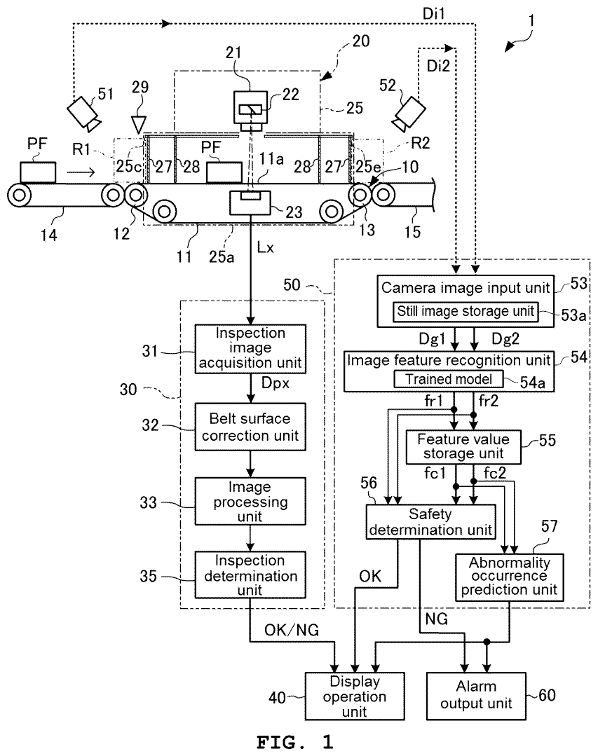

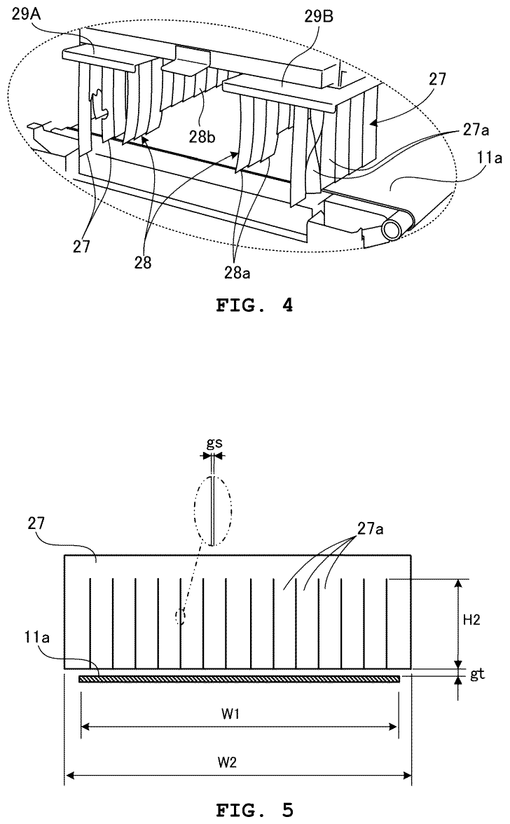

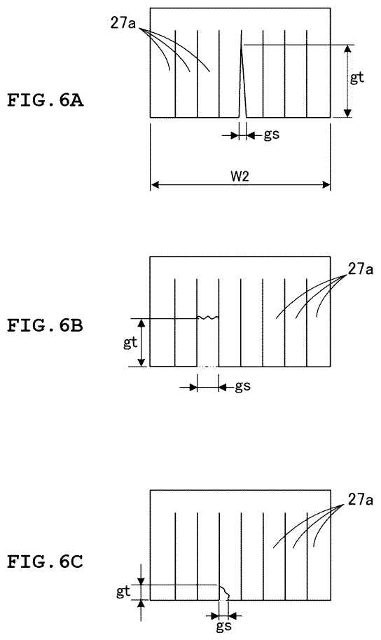

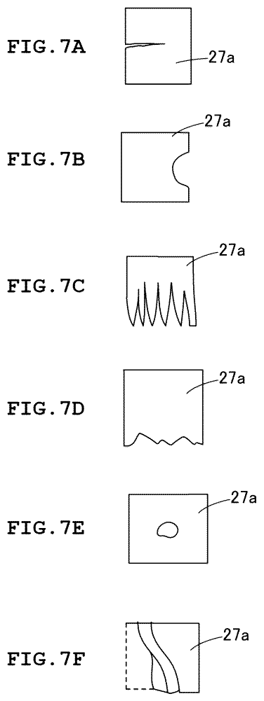

FIGS. 1 to 5 show an X-ray inspection apparatus according to the embodiment of the present invention, and FIGS. 6A to 7F schematically illustrate a plurality of deterioration forms of an X-ray shielding curtain in the apparatus.

First, a configuration of the X-ray inspection apparatus will be described.

An X-ray inspection apparatus 1 shown in FIG. 1 includes an article conveying section 10 that is a conveyor for inspection, an X-ray imaging section 20 that performs X-ray imaging on an inspection object PF (article), an inspection control section 30 that controls processing of article inspection based on an X-ray image obtained by the imaging, a display operation unit 40 that displays an output of the inspection control section 30 or receives an operation input, and an opening monitoring section 50 for ensuring safety. In addition, an upstream conveyor 14 is provided upstream of the article conveying section 10 in a conveyance direction, and a downstream conveyor 15, which is provided in combination with a sorting device or the like (not shown), is provided downstream of the article conveying section 10 in the conveyance direction.

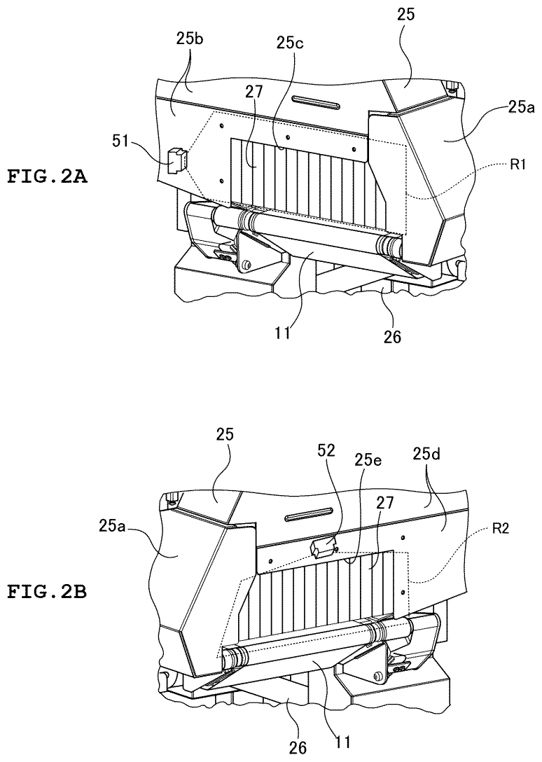

As shown in FIGS. 1 to 2B, the article conveying section 10 conveys the inspection object PF (article) in a predetermined conveyance direction, for example, the conveyance direction indicated by a rightward arrow in FIG. 1. For example, by driving any of rollers 12 and 13 around which a loop-shaped conveyance belt 11 is stretched, the inspection object PF on a conveyance path 11a, which is an upper traveling section of the belt, is conveyed at a predetermined speed and passed through an inspection region of the X-ray imaging section 20.

The inspection object PF is not particularly limited, but is, for example, a food or medicine to be taken orally, and in this case, is a product including a packaging container.

The X-ray imaging section 20 has an X-ray generator 21 and an X-ray detector 23 disposed with the conveyance path 11a of the article conveying section 10 interposed therebetween. The X-ray generator 21 and the X-ray detector 23 are disposed to face each other while being spaced apart above and below in a vertical direction, but the X-ray generator 21 and the X-ray detector 23 may be disposed to be spaced apart from each other in both the vertical direction and a horizontal direction. In addition, the article conveying section 10 may be configured by two belt conveyors arranged in the conveyance direction, and the X-ray detector may be disposed below a gap between the two belt conveyors.

Although not shown in detail, the X-ray generator 21 includes, for example, an X-ray tube 22 inside a metal housing, and has a configuration in which the X-ray tube 22 is immersed in insulating oil for cooling inside the housing. The X-ray generator 21 is an X-ray irradiation unit that irradiates a predetermined inspection region of the inspection object PF on the conveyance path 11a with X-rays, and, in the present embodiment, the X-ray generator 21 includes the X-ray tube 22 that irradiates the inspection object PF with X-rays from an upper side to a downward side in the vertical direction.

The X-ray tube 22 is disposed, for example, with its axial direction oriented substantially parallel to the predetermined conveyance direction, and is configured such that, on a cathode side, a DC negative potential is applied to a filament heated to a high temperature to emit electrons, which are focused by a focusing electrode, and, on an anode side, a DC positive potential is applied to a target so that electrons from the filament are accelerated by a high voltage to strike the target, thereby generating the X-rays in a predetermined energy range from the target.

Accordingly, the X-rays generated by the X-ray tube 22 are emitted downward from an X-ray window portion on a bottom side of the housing described above toward the inspection region into which the inspection object PF is conveyed, in the form of a fan beam that spreads in a line scanning direction orthogonal to the conveyance direction. An anode of the X-ray tube 22 may be either a fixed type or a rotating type. The X-ray imaging section 20 also includes a filament power supply circuit (not shown) and a high-voltage circuit that applies a high voltage between the filament of the X-ray tube 22 and the target.

The X-ray detector 23, although not shown in detail, is disposed, for example, directly below the conveyance path 11a of the conveyance belt 11, and is configured as a line sensor having a scintillator that emits light upon absorbing the X-rays of a predetermined energy (wavelength/transmission power) and a photodiode array composed of N (for example, several hundred) light-receiving elements arranged in a direction orthogonal to the conveyance direction of the inspection object PF to receive the light (scintillation light) from the scintillator. The X-ray detector 23 absorbs the X-rays emitted to and transmitted through the inspection object PF by the scintillator, emits light in accordance with the transmission intensity of the X-rays, and outputs an electrical signal corresponding to the amount of light received by the photodiode for each predetermined scanning cycle. It goes without saying that the X-ray detector 23 is not limited to an indirect conversion type that indirectly converts the X-rays into the electrical signal, and may be a direct conversion type.

The photodiode array of the X-ray detector 23 accumulates, for a predetermined integration time, the photocurrents generated simultaneously by the N light-receiving elements, and outputs a brightness detection signal Lx, which is a voltage signal, based on the charge proportional to the product of the photocurrent and the integration time.

On the other hand, the X-ray imaging section 20 includes a housing 25 having a substantially box-shaped radiation shielding structure supported by a leg portion 26, a portion of which is shown in FIGS. 2A and 2B, and a front cover 25a is provided on a front side of the housing 25, which can be opened to a front side over the conveyance path 11a. In addition, an inlet 25c into which the inspection object PF is conveyed and an outlet 25e from which the inspection object PF is conveyed are provided on both left and right side wall surfaces 25b and 25d of the housing 25, and a pair of opening-side shielding curtains 27 (curtain-shaped X-ray shielding members) that can close each opening in an X-ray shielding state are provided at the inlet 25c and the outlet 25e (hereinafter, simply referred to as opening portions 25c and 25e).

As shown in FIG. 4, at least one inner shielding curtain 28 that is located on an inner side of the housing 25 with respect to the pair of opening-side shielding curtains 27 and that is located on an inlet side and/or an outlet side with respect to the X-ray detector 23 is provided.

As shown in FIG. 5, each shielding curtain 27 has a shielding width W2 that is wider than a passage width W1 of the conveyance path 11a, and is formed in a curtain shape having a predetermined number of splits to have a plurality of strip-shaped portions 27a. As shown in FIG. 5, a predetermined number of 10 or more, or, as shown in FIGS. 6A to 6C, a predetermined number of less than, 10 of the plurality of strip-shaped portions 27a are provided to have the same height H2.

On the other hand, although not shown in detail, the inner shielding curtain 28 has a shielding width slightly wider than the passage width W1 of the conveyance path 11a but slightly narrower than the shielding width W2 of the shielding curtain 27, has a predetermined number of, for example, three strip-shaped portions 28a on both end sides having the same shape as the strip-shaped portions 27a on both end sides of the shielding width, and has six or more central strip-shaped portions 28b shorter than the strip-shaped portions 27a on a center side of the shielding width.

As a material of the shielding curtains 27 and 28, for example, lead, stainless steel, or the like, which is an X-ray shielding metal, is kneaded into or embedded in a resin or rubber, and specifically, for example, each of the strip-shaped portions 27a, 28a, and 28b is formed of so-called lead rubber in a curtain shape. However, in a case where the inspection object PF is of a type for which contact with lead is not permissible, a plurality of strip-shaped metal plates, for example, stainless steel plates may be arranged adjacent to each other in a direction of the shielding width W2 or the like, and each of the strip-shaped portions 27a, 28a, and 28b may be supported to be swingable in the conveyance direction at an upper end side thereof. Furthermore, a plurality of metal plates divided vertically at an intermediate height position of the strip-shaped portions may be connected to be swingable in the conveyance direction to allow multi-stage bending, or lower end portions thereof may be curved toward the downstream side in the conveyance direction.

Although the shielding curtains 27 and 28 are configured such that upper ends of the respective strip-shaped portions 27a, 28a, and 28b are supported by attachable and detachable support plates 29A and 29B, the strip-shaped portions 27a, 28a, and 28b may also be suspended and supported from a horizontal shaft supported by the support plates 29A and 29B.

Although not shown in detail, the inspection control section 30 is hardware-configured with, for example, a processor having a CPU, a ROM, a RAM, and an I/O interface, an auxiliary storage device that, in cooperation with the ROM, stores control programs for implementing various functions so as to be readable, and timer circuits, driver circuits, and the like. In accordance with software such as the control programs and setting information stored in the ROM, the CPU executes predetermined arithmetic processing while exchanging data with the RAM or the like and executes the control programs. The various functions referred to herein are functions of respective functional units and means for X-ray output control, X-ray image data generation, inspection control, display output control, and the like described later. In addition, the hardware referred to here may include a field programmable gate array (FPGA), a digital signal processor (DSP), a graphics processing unit (GPU), or the like.

As shown in FIG. 1, the inspection control section 30 is configured to include an inspection image acquisition unit 31, a belt surface correction unit 32, an image processing unit 33, and an inspection determination unit 35.

Specifically, the inspection image acquisition unit 31 acquires a brightness detection signal Lx for each line scanning from the photodiode array of the X-ray detector 23 to generate X-ray image data DpX. The belt surface correction unit 32 performs, for each of the N light-receiving elements, correction that equalizes the brightness detection signal Lx from the X-ray detector 23 obtained when the X-rays from the X-ray generator 21 pass only through the conveyance path 11a, which is a belt surface before the inspection object PF is conveyed in (when no inspection object PF is present) to a white reference value, that is, to perform light-receiving sensitivity correction (so-called shading correction) at the belt surface.

The image processing unit 33 has, for example, an image processing function for known foreign matter detection, or an image processing function for volume measurement and relative mass measurement, and the inspection determination unit 35 determines whether or not foreign matter is mixed in the inspection object PF based on a measurement result of the image processing unit 33, or determines whether or not measured values of volume and mass are within a predetermined allowable error range with respect to a reference value.

The display operation unit 40 is, for example, a touch panel type composed of a liquid crystal display (LCD) or the like, and has both a function of display means and a function of operation input means. The display operation unit 40 is not limited to a touch panel integrated with the X-ray inspection apparatus 1, and may be provided as a portable tablet-type information terminal, or may be additionally installed, separate from the touch panel integrated with the X-ray inspection apparatus 1, in the form of a display and control panel.

The opening monitoring section 50 includes, for example, opening imaging cameras 51 and 52 (opening imaging units) that are visible light cameras having a built-in DSP chip for signal processing, and a camera image input unit 53, an image feature recognition unit 54, a feature value storage unit 55, a safety determination unit 56, and an abnormality occurrence prediction unit 57, which are configured by an FPGA, a work memory, and the like that constitute a part of the inspection control section 30.

The opening imaging camera 51 on an inlet 25c side is located above the conveyance path 11a of the article conveying section 10 and upstream of a predetermined conveyance position of the inspection object PF, for example, upstream of an inlet detection position, at which the inspection object PF is conveyed into the X-ray imaging section 20, detected by an article detection sensor 39 such as a photoelectric sensor. The opening imaging camera 51 images an imaging region R1 of the housing 25 on the inlet 25c side, including an appearance of the shielding curtain 27 on the inlet side that blocks the inlet 25c to be shielded from X-rays, and outputs opening portion imaging data Di1.

In addition, the opening imaging camera 52 on an outlet 25e side is disposed above and downstream of the conveyance path 11a of the article conveying section 10, images an imaging region R2 of the housing 25 on the outlet 25e side, including an appearance of the shielding curtain 27 on the outlet side that blocks the outlet 25e to be shielded from X-rays, and outputs opening portion imaging data Di2.

An imaging timing of the imaging region R1 on the inlet 25c side by the opening imaging camera 51 is a timing at which the inspection object PF does not pass through the opening portion that is the inlet 25c or the outlet 25e, and more specifically, a timing at which, for example, the front cover 25a is closed and a waiting time for the detection of the inspection object PF by the article detection sensor 39 exceeds a predetermined waiting time, that is, the shielding state of the inlet 25c by the shielding curtain 27 on the inlet side is stabilized, or a timing at which the front cover 25a is closed, the number of inspections of the inspection object PF of a predetermined variety set as an inspection target variety by the inspection control section 30 reaches a set number of inspections, and the inspection is temporarily stopped to switch varieties. Hereinafter, a period in which the imaging timing is set without passing an article in this way is also referred to as a shielding period.

The opening portion imaging data Di1 and Di2 from the imaging cameras 51 and 52 are taken into the camera image input unit 53 of the opening monitoring section 50 at the timing at which the inspection object PF does not pass through the inlet 25c and the outlet 25e as described above, and are taken into the image feature recognition unit 54 via the camera image input unit 53.

The camera image input unit 53 can specify the predetermined imaging timing, that is, the timing at which the inspection object PF does not pass through the opening portion that is the inlet 25c or the outlet 25e, based on the article detection timing by receiving article detection information from the article detection sensor 39, and can receive opening portion images Dg1 and Dg2 from the opening imaging cameras 51 and 52.

The image feature recognition unit 54 performs processing of recognizing, as predetermined image feature values fr1 and fr2, classifiable morphological features of the shielding curtain 27 and its surroundings relating to the shielding state of the opening portions 25c and 25e appearing in the opening portion images Dg1 and Dg2 from the opening imaging cameras 51 and 52.

Here, the predetermined morphological features relating to the shielding state of the opening portions 25c and 25e are morphological features that allow classification of images in which the plurality of strip-shaped portions 27a of the shielding curtain 27 and portions of the conveyance belt 11 constituting the conveyance path 11a appear substantially identical shapes when the X-ray shielding function is exhibited while each of the opening portions 25c and 25e is blocked, and that allow, since the types of deterioration of the shielding curtain 27 within each classification can be identified based on external appearances such as gaps between the plurality of strip-shaped portions 27a and gaps between the shielding curtain 27 and the conveyance path 11a, classification and identification of deterioration states of the plurality of strip-shaped portions 27a of the shielding curtain 27 and of the conveyance belt 11 constituting the conveyance path 11a.

More specifically, for example, as shown in FIGS. 4 to 6C, in a case where deterioration such as warping, twisting, cracking, or the like occurs in any of the plurality of strip-shaped portions 27a of the shielding curtain 27 having a predetermined number of splits in the opening portion images Dg1 and Dg2, a gap gs in a substantially horizontal direction between the surfaces of the shielding curtain 27 increases due to the deterioration (see FIG. 6A), or a gap gt in a substantially vertical direction between a lower end of the shielding curtain 27 and the conveyance path 11a increases due to deterioration such as tearing or partial missing of the lower end portion of the shielding curtain 27 (see FIGS. 6B and 6C) or deterioration such as wear, breakage, or missing of the conveyance path 11a, which is a partial conveyance surface of the conveyor (see FIGS. 6B and 6C). Then, in the opening portion images Dg1 and Dg2 acquired under the deterioration state, at least a first gap gs that is a gap between the surfaces of the plurality of strip-shaped portions 27a of the shielding curtain 27 or a second gap gt that is a gap between the shielding curtain 27 and the conveyance path 11a (partial conveyance surface) of the conveyance belt 11 appears.

In this case, the first and second gaps gs and gt are recognized as the predetermined image feature values fr1 and fr2 that appear in the opening portion images Dg1 and Dg2 by the image feature recognition unit 54, and are stored as reference image feature values fc1 and fc2 by the feature value storage unit 55.

Then, the safety determination unit 56 accurately determines safety relating to the shielding function of the opening portions 25c and 25e by the shielding curtain 27 from a plurality of viewpoints based on a result of comparing at least the predetermined image feature values fr1 and fr2 of the opening portion images Dg1 and Dg2 recognized by the image feature recognition unit 54 with the reference image feature values fc1 and fc2 of the first and second gaps gs and gt stored in the feature value storage unit 55.

More specifically, the predetermined imaging regions R1 and R2 include the plurality of strip-shaped portions 27a of the shielding curtains 27 on the inlet side and the outlet side exposed in the opening portions 25c and 25e and the conveyance path 11a (the partial conveyance surface of the conveyor) located directly below the opening portions 25c and 25e. When at least the first gap gs between the surfaces of the shielding curtain 27 and the second gap gt between the shielding curtain 27 and the conveyance path 11a of the conveyance belt 11 appear in the opening portion images Dg1 and Dg2, the first and second gaps gs and gt are recognized as the predetermined image feature values fr1 and fr2 by the image feature recognition unit 54, and the recognized first gap gs and second gap gt are stored as the reference image feature values fc1 and fc2 by the feature value storage unit 55.

Then, the safety determination unit 56 determines the safety relating to the shielding function of the opening portions 25c and 25e by comparing the predetermined image feature values fr1 and fr2 of the opening portion images Dg1 and Dg2 recognized by the image feature recognition unit 54 during the current period or a recent predetermined period including the current period, with the reference image feature values fc1 and fc2 corresponding to at least the first gap gs and the second gap gt that are stored in the feature value storage unit 55, and determining whether or not a significant change has occurred therebetween.

Since the opening imaging cameras 51 and 52 image the opening portions 25c and 25e at a predetermined imaging cycle and repeatedly output the opening portion images Dg1 and Dg2 in each shielding period in which the inspection object PF does not pass through the opening portions 25c and 25e, and the reference image feature values fc1 and fc2 are stored and accumulated in the feature value storage unit 55 at a predetermined cycle, a change in the reference image feature values fc1 and fc2 stored and accumulated in the feature value storage unit 55 can be compared as a feature value change over a relatively long period, and the abnormality occurrence prediction unit 57 can predict and determine the occurrence of an abnormality in the shielding state of the shielding curtain 27 according to the degree of the change in the feature value over the relatively long period. The abnormality occurrence prediction unit 57 may store and save some old storage data that exceeds a storage accumulation period of the reference image feature values fc1 and fc2 in the feature value storage unit 55 for a longer storage period and time interval than the feature value storage unit 55.

On the other hand, the feature value storage unit 55 stores the predetermined image feature values fr1 and fr2 appearing in the opening portion images Dg1 and Dg2 when the shielding function of the opening portions 25c and 25e is normal as the reference image feature values fc1 and fc2 in a normal state (reference image feature values in a normal state), and stores the predetermined image feature values fr1 and fr2 appearing in the opening portion images Dg1 and Dg2 when the shielding function of the opening portions 25c and 25e is abnormal as the reference image feature values fc1 and fc2 in an abnormal state (reference image feature values in an abnormal state). Therefore, the safety determination unit 56 can determine the safety relating to the shielding function of the opening portions 25c and 25e by comparing the predetermined image feature values fr1 and fr2 of the opening portion images Dg1 and Dg2 recognized by the image feature recognition unit 54 during the current period or the recent predetermined period including the current period, with the reference image feature values fc1 and fc2 including at least the reference image feature values in the normal state and the reference image feature values in the abnormal state.

The image feature recognition unit 54 also has a trained model 54a that has been trained to detect, using a camera video in which a deterioration and wear state of at least one of a deterioration and wear state of the shielding curtain 27 and a deterioration and wear state of the conveyance belt 11 constituting the inspection conveyor is imaged, an object in the deterioration and wear state, and the safety determination unit 56 can determine the safety of the apparatus based on the trained model 54a in the image feature recognition unit 54 and the opening portion images Dg1 and Dg2 captured by the opening imaging cameras 51 and 52.

That is, the object detection referred to in the present invention is, for example, an object detection method of detecting the image feature values fc1 and fc2 from the opening portion image Dg1 using a rule (logic)-based technique such as pattern matching using the first gap gs and the second gap gt described above. However, the object detection is not limited thereto, and an object detection method of acquiring an object detection algorithm through AI learning using a neural network, for example, an object detection technique known as You Only Look Once (YOLO) or Single Shot Detector (SSD) may be used, and by detecting the predetermined image feature values fr1 and fr2 from the opening portion images Dg1 and Dg2 by the object detection, the deterioration states of the plurality of strip-shaped portions 27a of the shielding curtain 27 or the conveyance path 11a appearing in the opening portion images Dg1 and Dg2 can be accurately classified and recognized. In this case, not only imaging data that comprehensively images functional deterioration sites of the shielding curtain as shown in FIGS. 6A to 6C, but also partial image data of a predetermined image size imaging, for example, a plurality of types of deterioration sites of the strip-shaped portions 27a of the shielding curtain 27 as shown in FIGS. 7A to 7F and deterioration sites of the conveyance belt 11 and other parts may be prepared as a training dataset (image data and annotation data) for the object detection or object identification and used for learning. Then, based on the feature values of the deterioration forms (feature values corresponding to unevenness, peeling, wear, surface deterioration, and the like), an ability to classify and identify various deterioration forms can be improved.

The image feature recognition unit 54 may have the trained model 54a that has been trained in advance to recognize an object using a camera video in which the inspection object PF is imaged by the opening imaging cameras 51 and 52, and the safety determination unit 56 may determine the safety of the apparatus by identifying a specific object and other objects, a part of a human body, or the like other than the specific object based on the trained model 54a and the opening portion images Dg1 and Dg2 imaged by the opening imaging cameras 51 and 52.

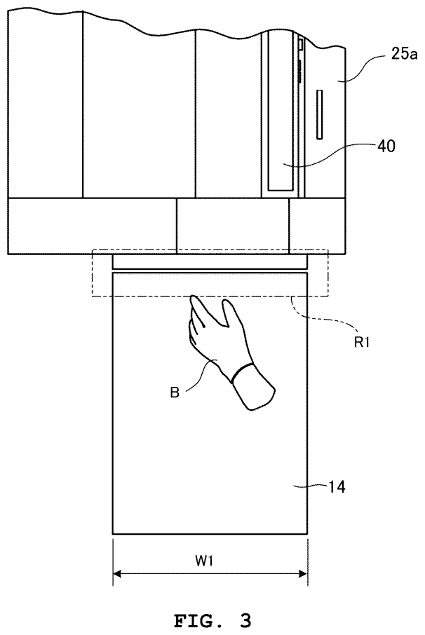

For example, the image feature recognition unit 54 has a human body detection function of recognizing that a part B of a human body as shown in FIG. 3 is inserted into any of the predetermined imaging regions R1 and R2 including the opening portions 25c and 25e based on the opening portion images Dg1 and Dg2. The safety determination unit 56 and the abnormality occurrence prediction unit 57 determine the safety of the apparatus based on detection information by the human body detection function when it is detected by the human body detection function of the image feature recognition unit 54 that the part B of the human body is inserted into the predetermined imaging region R1 or R2. When it is determined that an abnormality has occurred due to the insertion of the part B of the human body into the predetermined imaging region R1 or R2, the inspection control section 30 stops the X-ray irradiation by the X-ray imaging section 20 and the conveyance driving of the conveyance belt 11, and causes error information relating to the X-ray inspection to be output and displayed on the display operation unit 40.

The camera image input unit 53, by being configured by the FPGA, the work memory, and the like described above, also has a function as a still image storage unit 53a that stores a still image obtained from a camera video (moving image) from the opening imaging cameras 51 and 52, which are visible light cameras. The image feature recognition unit 54 performs image processing for recognizing, as the predetermined image feature values fr1 and fr2, classifiable morphological features relating to the shielding states of the opening portions 25c and 25e appearing in the opening portion images Dg1 and Dg2 and to the detection information by the human body detection function, based on the still image stored in the still image storage unit 53a. The safety determination unit 56 can determine the safety relating to the shielding states of the opening portions 25c and 25e appearing in the opening portion images Dg1 and Dg2 and to the detection information by the human body detection function.

The determination result output (OK/NG) of the safety determination unit 56 and the alarm output for notifying that an abnormality is predicted to occur from the abnormality occurrence prediction unit 57 are output to the display operation unit 40 and an alarm output unit 60 such as a warning lamp, respectively, and the display output and the alarm output are performed.

In this case, the opening imaging cameras 51 and 52 are simply exterior imaging units that image the opening portions 25c and 25e from outside the apparatus, but a camera that images the shielding state of the shielding curtain 27 may be further added on an inner side of the X-ray imaging section 20.

Next, operations will be described.

In the X-ray inspection apparatus 1 of the present embodiment configured as described above, during the aforementioned shielding period in which the inspection object PF does not pass through the opening portion that is the inlet 25c or the outlet 25e, for example, when a specific inspection object PF among a plurality of inspection objects PF being conveyed is detected by the article detection sensor 39 and a predetermined waiting time has elapsed thereafter so that the shielding state of the inlet 25c by the shielding curtain 27 on the inlet side is stabilized, and when a predetermined time has further elapsed so that the shielding state of the outlet 25e by the shielding curtain 27 on the outlet side is stabilized, the imaging regions R1 and R2 on the inlet 25c and outlet 25e sides are imaged by the opening imaging cameras 51 and 52 to image the shielding curtains 27, respectively. Alternatively, in a case where the front cover 25a is closed, when the number of inspections of the inspection object PF of the inspection target variety reaches the set number of inspections and the inspection is temporarily stopped for variety switching or the like, the imaging regions R1 and R2 on the inlet 25c and outlet 25e sides are imaged by the opening imaging cameras 51 and 52 to image the shielding curtains 27, respectively.

In this case, the opening portion imaging data Di1 and Di2 output from the opening imaging cameras 51 and 52 are taken into the camera image input unit 53, and the opening portion images Dg1 and Dg2 captured during the current period or a recent predetermined period including the current period are output from the camera image input unit 53 and are taken into the image feature recognition unit 54.

Then, based on the taken opening portion images Dg1 and Dg2, the first gap gs and the second gap gt described above and the like in the periphery of each shielding curtain 27 in the imaging regions R1 and R2 are detected by the image feature recognition unit 54 as the predetermined image feature values fr1 and fr2 that enable morphological classification and identification of the deterioration states of the shielding curtain 27 or the like, and are stored as the reference image feature values fc1 and fc2 corresponding to the feature value storage unit 55.

Furthermore, as described above, based on the predetermined image feature values fr1 and fr2 detected during the current period or a recent predetermined period including the current period and the reference image feature values fc1 and fc2 stored in the feature value storage unit 55, the safety determination unit 56 determines the safety, the abnormality occurrence prediction unit 57 predicts the occurrence of the abnormality, and the determination result of the safety by the safety determination unit 56 and the alarm output from the abnormality occurrence prediction unit 57 are output to the display operation unit 40 and the alarm output unit 60 such as a warning lamp as necessary.

In this way, in the present embodiment, when the predetermined imaging regions R1 and R2 including the opening portions 25c and 25e are imaged by the opening imaging cameras 51 and 52 and are output as the opening portion images Dg1 and Dg2 during the shielding period in which the inspection object PF does not pass through the opening portion that is the inlet 25c or the outlet 25e, and the classifiable morphological features relating to the shielding states of the opening portions 25c and 25e appearing in the opening portion images Dg1 and Dg2 are recognized as the predetermined image feature values fr1 and fr2 by the image feature recognition unit 54, for example, are projected into a feature space as a feature vector, safety relating to the shielding function of the opening portions 25c and 25e by the shielding curtain 27 is accurately determined by the safety determination unit 56 based on the image feature values fr1 and fr2. Therefore, the X-ray inspection apparatus 1 can reliably detect various deteriorations or abnormalities of shielding performance at the opening portions 25c and 25e having the shielding curtain 27 with a simple configuration and can sufficiently improve safety.

In addition, in the present embodiment, in a case where deterioration such as warping, twisting, cracking, or the like occurs in any of the plurality of strip-shaped portions of the shielding curtain 27 having a predetermined number of splits, the gap gs in a substantially horizontal direction between the surfaces of the shielding curtain 27 increases due to the deterioration, or the gap gt in a substantially vertical direction between the lower end of the shielding curtain 27 and the conveyance path 11a increases due to deterioration such as tearing or partial missing of the lower end portion of any of the strip-shaped portions 27a of the shielding curtain 27 or deterioration such as wear, breakage, or missing of the partial conveyance surface of the conveyance belt 11, in the opening portion images Dg1 and Dg2 acquired under the deterioration state, at least the first gap gs that is a gap between the surfaces of the shielding curtain 27 or the second gap gt that is a gap between the shielding curtain 27 and the partial conveyance surface of the conveyor appears.

In this case, the first and second gaps are recognized as the image feature values by the image feature recognition unit 54 and are stored in the feature value storage unit 55 as the reference image feature values fc1 and fc2, and the safety determination unit 56 accurately determines the safety relating to the shielding function of the opening portions 25c and 25e based on a result of comparing the image feature value of the opening portion images Dg1 and Dg2 recognized by the image feature recognition unit 54 during the current period or a recent predetermined period including the current period with at least the reference image feature values fc1 and fc2 of the first and second gaps.

Furthermore, in the present embodiment, during the shielding period in which the inspection object PF does not pass through the opening portions 25c and 25e, the opening portion images Dg1 and Dg2 including the shielding state of the shielding curtain 27 are repeatedly output, and the predetermined image feature values fr1 and fr2 appearing in the opening portion images Dg1 and Dg2 are accumulated and stored in the feature value storage unit 55 as the reference image feature values fc1 and fc2. Therefore, not only can the safety determination be performed by the safety determination unit 56, but also the occurrence of an abnormality in the shielding state of the shielding curtain 27 can be predicted and determined based on the reference image feature values fc1 and fc2 accumulated in the feature value storage unit 55 by the abnormality occurrence prediction unit 57.

That is, during the shielding period of the opening portions 25c and 25e, the opening portion images Dg1 and Dg2 including the shielding state of the shielding curtain 27 are repeatedly output at a predetermined imaging cycle, and the predetermined image feature values fr1 and fr2 of the output opening portion images Dg1 and Dg2 are sequentially stored and accumulated in the feature value storage unit 55. Then, the safety determination unit 56 predicts and determines the occurrence of an abnormality in the shielding state of the shielding curtain 27 based on the predetermined image feature values fr1 and fr2 of a plurality of the opening portion images Dg1 and Dg2 sequentially stored as the reference image feature values fc1 and fc2 in the feature value storage unit 55 and the degree of deterioration of the shielding curtain 27 or the conveyance belt 11, which is recognized as the degree of change.

In addition, in the present embodiment, the feature value storage unit 55 stores the predetermined image feature values fr1 and fr2 appearing in the opening portion images Dg1 and Dg2 when the shielding function of the opening portions 25c and 25e is normal as the reference image feature values in a normal state, and stores the predetermined image feature values fr1 and fr2 appearing in the opening portion images Dg1 and Dg2 when the shielding function of the opening portions 25c and 25e is abnormal as the reference image feature values in an abnormal state. Therefore, the safety determination unit 56 determines the safety relating to the shielding function of the opening portions 25c and 25e by comparing the image feature value of the opening portion images Dg1 and Dg2 recognized by the image feature recognition unit 54 during the recent predetermined period with the reference image feature values fc1 and fc2 including at least the reference image feature values in the normal state and the reference image feature values in the abnormal state, which are stored in the feature value storage unit 55. Then, in a case where a significant change in image feature values occurs toward the reference image feature values in the abnormal state in the opening portion images Dg1 and Dg2 recognized during the recent predetermined period, a decrease in the safety relating to the shielding function of the opening portions 25c and 25e is determined.

In addition, in the present embodiment, the image feature recognition unit 54 has the trained model 54a that has been trained to detect, using a camera video in which a deterioration and wear state of at least one of a deterioration and wear state of the shielding curtain 27 and a deterioration and wear state of the conveyance belt 11 is imaged, an object in the deterioration and wear state, and the safety determination unit 56 determines the safety of the apparatus based on the trained model 54a and the opening portion images Dg1 and Dg2 captured by the opening imaging cameras 51 and 52. Therefore, even in a case where the deterioration and wear state of the shielding curtain 27 and/or the conveyance belt 11 is not easily measurable quantitatively as a specific location or for a specific deterioration type, a significant deterioration state can be accurately determined by the object detection method at a determination level of an expert. That is, based on the trained model 54a and the opening portion images Dg1 and Dg2 captured by the opening imaging cameras 51 and 52, accurate safety determination can be performed by the safety determination unit 56.

In addition, in the present embodiment, the image feature recognition unit 54 has the trained model 54a that has been trained in advance to recognize an object using a camera video in which the inspection object PF is imaged, and the safety determination unit 56 determines the safety of the apparatus based on the trained model 54a and the opening portion images Dg1 and Dg2 captured by the opening imaging cameras 51 and 52. Therefore, in a case where an object other than the inspection object PF is recognized as an object from the opening portion images Dg1 and Dg2 based on the camera video by the trained model 54a, it is recognized that an object other than the inspection object PF approaches the opening portions 25c and 25e, and a state in which the safety of the apparatus is impaired can be determined in advance. On the other hand, in a case where the inspection object PF is recognized as an object from the opening portion images Dg1 and Dg2 based on the camera video by the trained model 54a, it is determined that the inspection object PF approaches the opening portions 25c and 25e and a state in which the safety of the apparatus is maintained can be determined.

Furthermore, in the present embodiment, when it is detected by the human body detection function of the image feature recognition unit 54 that the part B of the human body is inserted into the predetermined imaging regions R1 and R2, the safety determination unit 56 determines the safety of the apparatus based on the human body detection information from the image feature recognition unit 54. Therefore, when it is detected by the human body detection function of the image feature recognition unit 54 that the part B of the human body is inserted into the predetermined imaging regions R1 and R2, the inspection control section 30 executes control of stopping the X-ray irradiation by the X-ray imaging section 20 and the conveyor conveyance driving by the conveyance belt 11 and outputting the error information relating to the X-ray inspection to the display operation unit 40 or the alarm output unit 60. Therefore, not only the safety determination according to the degree of deterioration of the shielding curtain 27 and the conveyance belt 11 but also the safety determination based on the human body detection function can be accurately executed. It is possible to effectively prevent the occurrence of a human error in an emergency response or the like in advance.

In addition, in the present embodiment, the still image storage unit 53a that stores the still image obtained from the camera video is further provided, and the image feature recognition unit 54 recognizes the classifiable morphological features relating to the shielding states of the opening portions 25c and 25e appearing in the opening portion images Dg1 and Dg2 and to the detection information by the human body detection function as the predetermined image feature values fr1 and fr2 based on the still image stored in the still image storage unit 53a. Therefore, a change in the shielding state of the opening portions 25c and 25e or the insertion operation of the part of the human body can be quickly and accurately detected as a change in the predetermined image feature values fr1 and fr2 with respect to the reference image feature values fc1 and fc2 based on a plurality of the still images obtained at a relatively short time interval from the camera video, and the safety determination can be more accurately performed.

As described above, according to the present embodiment, it is possible to provide the X-ray inspection apparatus 1 capable of reliably detecting various deteriorations or abnormalities of shielding performance at the opening portions 25c and 25e having the shielding curtain 27 with a simple configuration and of sufficiently improving safety.

### Another Embodiment

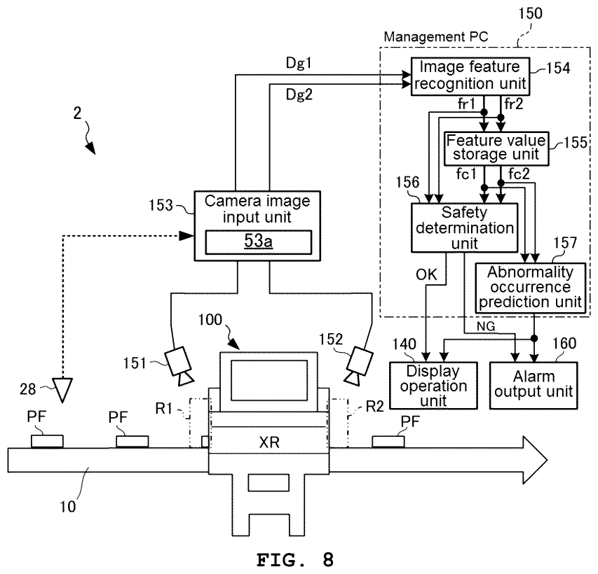

FIG. 8 shows an X-ray inspection system according to another embodiment of the present invention.

In addition, the configurations that are same as or similar to the above-described embodiment are denoted by the same reference numerals as the corresponding components in the embodiment shown in FIGS. 1 to 7, and redundant detailed descriptions are omitted.

An X-ray inspection system 2 of the present embodiment includes an X-ray inspection apparatus 100 including the housing 25 having the opening portions 25c and 25e through which the inspection object PF is conveyed in a predetermined direction by the article conveying section 10, the X-ray imaging section 20 that images the inspection object PF with X-rays in the housing 25, the image processing unit 33 that inspects quality of the inspection object PF based on the X-ray image Dpx from the X-ray imaging section 20, and the shielding curtain 27 that is disposed at the opening portions 25c and 25e.

The X-ray inspection system 2 of the present embodiment further includes a management PC 150 having a display operation unit 140, opening imaging cameras 151 and 152, a camera image input unit 153, an image feature recognition unit 154, a feature value storage unit 155, a safety determination unit 156, and an abnormality occurrence prediction unit 157, and an alarm output unit 160 such as an alarm lamp, and the management PC 150 is configured to perform the same functions as the opening monitoring section 50 in the embodiment described above.

Here, the opening imaging cameras 151 and 152 are provided outside the X-ray inspection apparatus 100 in an independent manner to image the predetermined imaging regions R1 and R2 including the opening portions 25c and 25e during the shielding period in which the inspection object PF does not pass through the opening portions 25c and 25e and output the imaging regions R1 and R2 as the opening portion images Dg1 and Dg2.

The camera image input unit 153 can specify the shielding period in which the inspection object PF does not pass through the inlet 25c and the outlet 25e by receiving the article detection information from the article detection sensor 39, and can receive the opening portion images Dg1 and Dg2 from the opening imaging cameras 151 and 152.

The image feature recognition unit 154 recognizes the classifiable morphological features of the shielding curtain 27 and the like relating to the shielding states of the opening portions 25c and 25e appearing in the opening portion images Dg1 and Dg2 from the opening imaging cameras 151 and 152 as predetermined image feature values fr1 and fr2.

The feature value storage unit 155 stores the predetermined image feature values fr1 and fr2 appearing in the opening portion images Dg1 and Dg2 relating to the deterioration of the shielding function of the opening portions 25c and 25e as the reference image feature values fc1 and fc2, and can store and accumulate the predetermined image feature values fr1 and fr2 as the reference image feature values fc1 and fc2 each time the predetermined image feature values fr1 and fr2 are output from the image feature recognition unit 154.

The safety determination unit 156 determines the safety relating to the shielding function of the opening portions 25c and 25e by the shielding curtain 27 based on the predetermined image feature values fr1 and fr2 recognized by the image feature recognition unit 154 and the reference image feature values fc1 and fc2 stored in the feature value storage unit 155.

When the opening imaging cameras 151 and 152 image the opening portions 25c and 25e at a predetermined imaging cycle and repeatedly output the opening portion images Dg1 and Dg2 during each shielding period in which the inspection object PF does not pass through the opening portions 25c and 25e, the abnormality occurrence prediction unit 157 can compare the change in the reference image feature values fc1 and fc2 stored and accumulated in the feature value storage unit 155 at a predetermined cycle as a change in feature value over a relatively long period, and can predict and determine the occurrence of an abnormality in the shielding state of the shielding curtain 27 according to the degree of the change in the feature value over the relatively long period.

In the present embodiment as well, during the shielding period in which the inspection object PF does not pass through the opening portions 25c and 25e, the predetermined imaging regions R1 and R2 including the opening portions 25c and 25e are imaged by the opening imaging cameras 151 and 152, and are taken into the management PC via the camera image input unit 153 as the opening portion images Dg1 and Dg2. Then, in a case where the classifiable morphological features relating to the shielding states of the opening portions 25c and 25e appearing in the opening portion images Dg1 and Dg2 are recognized as the predetermined image feature values fr1 and fr2 by the image feature recognition unit 154, the predetermined image feature values fr1 and fr2 are compared with the reference image feature values fc1 and fc2 accumulated in the feature value storage unit 155 by the safety determination unit 156, and the safety relating to the shielding function of the opening portions 25c and 25e by the shielding curtain 27 is accurately determined. As a result, the X-ray inspection system 2 can reliably detect various deteriorations or abnormalities of shielding performance at the opening portion of the X-ray inspection apparatus 100 having the shielding curtain 27 with a simple configuration and can sufficiently improve safety.

It goes without saying that the X-ray inspection system 2 can be configured as an article inspection system in which other article inspection apparatuses, for example, a weight sorting machine or a metal foreign matter detection apparatus, are arranged on the same inspection line. In addition, although all of the opening imaging cameras 51, 52, 151, and 152 are visible light cameras, as a matter of course, the opening imaging cameras 51, 52, 151, and 152 are not limited to the visible light cameras as long as the change in the morphological feature of the opening portion in the shielding state can be visualized depending on the variety of the inspection object PF. Furthermore, it is also considered to provide a near-infrared camera, a multispectral camera, or the like for the human body detection function. In addition, although the opening imaging cameras 51 and 52 in FIGS. 2A and 2B are disposed at a position for imaging the inlet 25c from a side and a position for imaging the outlet 25e from above, as a matter of course, the opening imaging cameras 51 and 52 may also be disposed at the opening portions on opposite sides. It goes without saying that each of the imaging cameras 51 and 52 may be at a position and a posture at which the entire opening portion including the appearance of the shielding curtain and the gap between the shielding curtain and the conveyance belt surface can be imaged with respect to the corresponding opening portion without hindering the conveyance of the inspection object, and the installation locations and the number of the opening imaging cameras 51, 52, 151, and 152, the line-of-sight direction, and the angle of view during imaging are optional.

As described above, the present invention can provide an X-ray inspection apparatus and an X-ray inspection system that can reliably detect various deteriorations or abnormalities of shielding performance at an opening portion having a shielding curtain with a simple configuration and can sufficiently improve safety. The present invention is useful for general X-ray inspection apparatuses and X-ray inspection systems that inspect a quality state of an inspection object based on an X-ray inspection image of the inspection object obtained by imaging the inspection object with X-rays.

### DESCRIPTION OF REFERENCE NUMERALS AND SIGNS

1 X-ray inspection apparatus
2 X-ray Inspection System
10 Article conveying section (conveyor)
11 Conveyance belt
11a Conveyance path (partial conveyance surface of conveyor)
12, 13 Roller
14 Upstream conveyor
15 Downstream conveyor
20 X-ray imaging section
21 X-ray generator
22 X-ray tube
23 X-ray detector
25 Housing
25a: Front cover
25b, 25d Left and right side wall surfaces
25c inlet (opening portion)
25e outlet (opening portion)
26 Leg portion
27 Shielding curtain
27a Strip-shaped portion
28 Inner shielding curtain
28a Strip-shaped portion on both end sides
28b Central strip-shaped portion
29A, 29B Support plate
30 Inspection control section
31 Inspection image acquisition unit
32 Belt surface correction unit
33 Image processing unit
35 Inspection determination unit
39 Article detection sensor
40 Display operation unit
50 Opening monitoring section
51, 52 Opening imaging camera (opening imaging unit, morphological feature imaging unit)
53 Camera image input unit
53a Still image storage unit
54 Image feature recognition unit
54a Trained model
55 Feature value storage unit
56 Safety determination unit
57 Abnormality occurrence prediction unit
60 Alarm output unit
100 X-ray inspection apparatus
140 Display operation unit
150: Management PC
151, 152 Opening imaging camera
153 Camera image input unit
154 Image feature recognition unit
155 Feature value storage unit
156 Safety determination unit
157 Abnormality occurrence prediction unit
160 Alarm output unit
B Part of human body
Di1, Di2 Opening portion imaging data
Dg1, Dg2 Opening portion image
fc1, fc2 Reference image feature value (classifiable morphological feature, image feature value)
fr1, fr2 Predetermined image feature value
gs First gap
gt Second gap
H2 Height (height of strip-shaped portion)
Lx Brightness detection signal
PF Inspection object
R1, R2 Imaging region
W1 Conveyance path width (passage width)
W2 Shielding width (curtain width)

What is claimed is:

1. An X-ray inspection apparatus comprising:
a housing having an opening portion through which an inspection object is conveyed in a predetermined direction by a conveyor;
an X-ray imaging section that images the inspection object with X-rays in the housing;
an image processing unit that inspects quality of the inspection object based on an X-ray image from the X-ray imaging section;
a shielding curtain that is disposed at the opening portion;
an opening imaging unit that images a predetermined imaging region including the opening portion and outputs the predetermined imaging region as an opening portion image at a timing at which the inspection object does not pass through the opening portion;
an image feature recognition unit that recognizes a morphological feature of a shielding state of the opening portion that is classifiable from the opening portion image from the opening imaging unit as a predetermined image feature value; and
a safety determination unit that determines safety relating to a shielding function of the shielding curtain at the opening portion based on the predetermined image feature value recognized by the image feature recognition unit.

2. The X-ray inspection apparatus according to claim 1,
wherein the predetermined imaging region includes surfaces of the shielding curtain exposed in the opening portion and a partial conveyance surface of the conveyor located directly below the opening portion,
at least a first gap between the surfaces of the shielding curtain and a second gap between the shielding curtain and the partial conveyance surface of the conveyor are each recognized as the predetermined image feature value by the image feature recognition unit from the opening portion image,
a feature value storage unit that stores each of the recognized first gap and second gap as a reference image feature value is provided, and
the safety determination unit determines the safety relating to the shielding function of the shielding curtain at the opening portion by comparing the predetermined image feature value of the opening portion image recognized by the image feature recognition unit during a recent predetermined period with the reference image feature value corresponding to at least the first gap and the second gap.

3. The X-ray inspection apparatus according to claim 2,
wherein the opening imaging unit images the opening portion including a shielding state of the shielding curtain at a predetermined imaging cycle during a shielding period in which the inspection object does not pass through the opening portion, and repeatedly outputs an opening portion image including the shielding state of the shielding curtain,
the feature value storage unit is configured to store and accumulate the predetermined image feature value of the opening portion image for the opening portion image including the shielding state of the shielding curtain at a predetermined cycle, and
the safety determination unit predicts and determines occurrence of an abnormality in the shielding state of the shielding curtain based on the predetermined image feature value of the opening portion image stored in the feature value storage unit at the predetermined cycle.

4. The X-ray inspection apparatus according to claim 2,
wherein the feature value storage unit stores the predetermined image feature value appearing in the opening portion image when a shielding function of the opening portion is normal as a reference image feature value in a normal state, and stores the predetermined image feature value appearing in the opening portion image when the shielding function of the opening portion is abnormal as a reference image feature value in an abnormal state, and
the safety determination unit determines the safety relating to the shielding function of the shielding curtain at the opening portion by comparing the predetermined image feature value of the opening portion image recognized by the image feature recognition unit during the recent predetermined period with the reference image feature value including at least the reference image feature value in the normal state and the reference image feature value in the abnormal state.

5. The X-ray inspection apparatus according to claim 1, further comprising:
a trained model that has been trained to detect, using a camera video in which a deterioration and wear state of at least one of a deterioration and wear state of the shielding curtain and a deterioration and wear state of a conveyance belt constituting the conveyor is imaged, an object in the deterioration and wear state,
wherein the safety determination unit determines safety of the X-ray inspection apparatus based on the trained model and the opening portion image captured by the opening imaging unit.

6. The X-ray inspection apparatus according to claim 1, further comprising:
a trained model that has been trained in advance to recognize an object using a camera video in which the inspection object is imaged,
wherein the safety determination unit determines safety of the X-ray inspection apparatus based on the trained model and the opening portion image captured by the opening imaging unit.

7. The X-ray inspection apparatus according to claim 1,
wherein the image feature recognition unit has a human body detection function of recognizing that a part of a human body is inserted into the predetermined imaging region including the opening portion based on the opening portion image,
the safety determination unit determines safety of the X-ray inspection apparatus based on detection information by the human body detection function when it is detected by the human body detection function of the image feature recognition unit that the part of the human body is inserted into the predetermined imaging region, and
the X-ray inspection apparatus further comprises an inspection control section that stops X-ray irradiation by the X-ray imaging section and conveyance driving of the conveyor and outputs error information relating to X-ray inspection when it is detected by the human body detection function that the part of the human body is inserted into the predetermined imaging region.

8. The X-ray inspection apparatus according to claim 7, further comprising:
a still image storage unit that stores a still image obtained from a camera video,
wherein the image feature recognition unit performs image processing for recognizing, as the predetermined image feature value, a classifiable morphological feature relating to the shielding state of the opening portion appearing in the opening portion image and to the detection information by the human body detection function, based on the still image stored in the still image storage unit, and
the safety determination unit determines safety relating to the shielding state of the opening portion appearing in the opening portion image to the detection information by the human body detection function.

9. The X-ray inspection apparatus according to claim 3,
wherein the feature value storage unit stores the predetermined image feature value appearing in the opening portion image when a shielding function of the opening portion is normal as a reference image feature value in a normal state, and stores the predetermined image feature value appearing in the opening portion image when the shielding function of the opening portion is abnormal as a reference image feature value in an abnormal state, and
the safety determination unit determines the safety relating to the shielding function of the shielding curtain at the opening portion by comparing the predetermined image feature value of the opening portion image recognized by the image feature recognition unit during the recent predetermined period with the reference image feature value including at least the reference image feature value in the normal state and the reference image feature value in the abnormal state.

10. The X-ray inspection apparatus according to claim 2, further comprising:
a trained model that has been trained to detect, using a camera video in which a deterioration and wear state of at least one of a deterioration and wear state of the shielding curtain and a deterioration and wear state of a conveyance belt constituting the conveyor is imaged, an object in the deterioration and wear state,
wherein the safety determination unit determines safety of the X-ray inspection apparatus based on the trained model and the opening portion image captured by the opening imaging unit.

11. The X-ray inspection apparatus according to claim 2, further comprising:
a trained model that has been trained in advance to recognize an object using a camera video in which the inspection object is imaged,
wherein the safety determination unit determines safety of the X-ray inspection apparatus based on the trained model and the opening portion image captured by the opening imaging unit.

12. The X-ray inspection apparatus according to claim 2,
wherein the image feature recognition unit has a human body detection function of recognizing that a part of a human body is inserted into the predetermined imaging region including the opening portion based on the opening portion image,
the safety determination unit determines safety of the X-ray inspection apparatus based on detection information by the human body detection function when it is detected by the human body detection function of the image feature recognition unit that the part of the human body is inserted into the predetermined imaging region, and
the X-ray inspection apparatus further comprises an inspection control section that stops X-ray irradiation by the X-ray imaging section and conveyance driving of the conveyor and outputs error information relating to X-ray inspection when it is detected by the human body detection function that the part of the human body is inserted into the predetermined imaging region.

13. The X-ray inspection apparatus according to claim 12, further comprising:
a still image storage unit that stores a still image obtained from a camera video,
wherein the image feature recognition unit performs image processing for recognizing, as the predetermined image feature value, a classifiable morphological feature relating to the shielding state of the opening portion appearing in the opening portion image and to the detection information by the human body detection function, based on the still image stored in the still image storage unit, and
the safety determination unit determines safety relating to the shielding state of the opening portion appearing in the opening portion image and to the detection information by the human body detection function.

14. An X-ray inspection system comprising:
an X-ray inspection apparatus including a housing having an opening portion through which an inspection object is conveyed in a predetermined direction by a conveyor, an X-ray imaging section that images the inspection object with X-rays in the housing, an image processing unit that inspects quality of the inspection object based on an X-ray image from the X-ray imaging section, and a shielding curtain that is disposed at the opening portion;
an opening imaging camera that is provided outside the X-ray inspection apparatus in an independent manner to image a predetermined imaging region including the opening portion and output the predetermined imaging region as an opening portion image at a timing at which the inspection object does not pass through the opening portion;
an image feature recognition unit that recognizes a morphological feature of a shielding state of the opening portion that is classifiable from the opening portion image from the opening imaging camera as a predetermined image feature value; and
a safety determination unit that determines safety relating to a shielding function of the shielding curtain at the opening portion based on the predetermined image feature value recognized by the image feature recognition unit.
